(19) United States
(12) Patent Application Publication
(10) Pub. No.: US 2005/0276320 A1
(43) Pub. Date: Dec. 15, 2005

(54) Signal transmission system and signal transmission method

(75) Inventors: Susumu Tsubosaka, Sagamihara-shi (JP); Hitomaro Tohgoh, Yokohama-shi (JP); Nobuhisa Kanetaka, Machida-shi (JP); Shohei Yamanaka, Yokohama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 11/148,672

(22) Filed: Jun. 9, 2005

(30) Foreign Application Priority Data
Jun. 10, 2004 (JP) 2004-172121

(51) Int. Cl. H04L 5/16

(52) U.S. Cl. 375/220

(57) ABSTRACT

To provide a signal transmission system which can increase the number of slave stations being coupled with a simple configuration, A master station 10 communicates with a plurality of slave stations 20 each having an antenna 25. The slave station 20 includes a frequency converter 26 for converting a signal of a radio frequency band received through the antenna into an intermediate frequency band signal, and an E/O converter 27 for converting an electrical signal into an optical signal. The master station 10 includes O/E converters 14a to 14c for converting signals received from the slave stations 20 into electrical signals, respectively, a synthesizer 17 for synthesizing the signals thus converted into the electrical signals and a frequency converter 18 for converting the synthesized signal into a radio frequency band signal.

### BACKGROUND OF THE INVENTION

1. Field of the Invention

The present invention relates to a signal transmission system including slave stations each performs radio communication with a portable terminal etc. for example, and a master station coupled to the slave stations through optical transmission paths and also relates to a signal transmission method.

2. Description of the Related Art

In recent years, in a radio communication system such as a mobile communication system, as a countermeasure for a dead zone area to which a radio signal does not reach, there is a signal transmission system (antenna distribution system) in which a master station is provided on a radio base station side, the master station is coupled to antenna devices (hereinafter called slave stations) through optical transmission paths, and the slave stations cover the communication of dead zone areas, respectively.

Since such a signal transmission system is considered to be used within an apartment house, a building etc., the signal transmission system is desired to be cheap and have many slave stations being coupled.

An optical transmission system which performs optical communication between a master station and slave stations among which radio communication is performed is described in the JP-A-2001-156720, for example.

However, in such a system, since signals from the slave stations are synthesized, noises of signals received from the respective slave stations are synthesized and so a CNR (carrier to noise ratio) of the synthesized signal is degraded.

Since it is necessary to keep the CNR to a predetermined value or more in order to maintain the communication quality, there is a circumstance that the number of the slave stations within the system, that is, the number of the slave stations to be coupled to the master station is limited.

### SUMMARY OF THE INVENTION

The invention has been made in view of the aforesaid conventional circumstance and an object of the invention is to provide a signal transmission system which can increase the number of slave stations being coupled with a simple configuration.

A master station in the signal transmission system of the invention is the master station for the signal transmission system which includes a plurality of slave stations each intended for communication and the master station coupled to the plurality of slave stations through optical transmission paths, respectively, including:
a plurality of optical/electro conversion means for converting up optical signals of an intermediate frequency band received from the plurality of slave stations into electrical signals, respectively;
synthesizing means for synthesizing the plurality of up signals; and
frequency conversion means for converting the up signal of the intermediate frequency band into a signal of a desired frequency band by using a reference signal of a predetermined frequency.

According to this configuration, since the optical transmission characteristics can be improved, the number of the slave stations being coupled can be increased.

Further, it is preferable that the master station further includes reference signal generation means for generating the reference signal. According to this configuration, the master station can generate the reference signal.

Further, it is preferable that the reference signal generation means includes signal generation means for generating a signal of a first frequency and reference signal frequency conversion means for converting the first frequency signal into the predetermined frequency signal. According to this configuration, even when the predetermined frequency signal can not be generated, the reference signal for frequency-converting the up signal into a signal of the desired frequency can be generated.

Further, it is preferable that the master station further includes means for receiving the reference signal from the outside. According to this configuration, since the reference signal is received from the outside of the master station, the master station can be miniaturized.

Further, it is preferable that the master station further includes coupling means for frequency-multiplexing and coupling the reference signal with a down signal for the slave station. According to this configuration, the reference signal can be transmitted in a multiplexed manner to the slave station.

Further, it is preferable that the master station further includes means for multiplying the reference signal; and coupling means for frequency-multiplexing and coupling the multiplied reference signal with a down signal for the slave station.

Further, it is preferable that the frequency conversion means for converting the intermediate frequency band signal into the desired frequency band signal is disposed at a rear stage of the synthesizing means for synthesizing the plurality of up signals. According to this configuration, since the frequency conversion is made after synthesizing the up signals, the number of the frequency conversion means can be reduced.

Further, it is preferable that the up signal received from the slave station is frequency-multiplexed with the reference signal, and the master station further includes split means for branching the reference signal from the up signal. According to this configuration, the up signal can be frequency-converted into a signal of the desired frequency by the reference signal which is superimposed on the up signal received from the slave station.

Further, it is preferable that the up signal received from the slave station is frequency-multiplexed with a signal of a second frequency, and the master station further includes split means for branching the second frequency signal from the up signal; and reference signal frequency conversion means for converting the second frequency signal into the predetermined frequency signal and outputting the predetermined frequency signal as the reference signal. According to this configuration, even when the predetermined frequency signal can not be generated in the slave station, the reference signal for frequency-converting the up signal into a signal of the desired frequency can be generated.

Further, it is preferable that the frequency conversion means for converting the intermediate frequency band signal into the desired frequency band signal is disposed at a front stage of the synthesizing means for synthesizing the plurality of up signals. According to this configuration, the up signal can be frequency-converted into a signal of the desired frequency by the reference signal which is superimposed on the up signal received from each of the slave stations.

Further, it is preferable that the master station further includes means for amplifying or attenuating each of the up signals received from the plurality of slave stations; detecting means for detecting a signal level of the up signal; and gain control means for controlling a gain of the amplifying or attenuating means when the detecting means does not detect the up signal. According to this configuration, the power saving and the improvement of the signal quality can be realized by controlling the amplifying or attenuating means when the signal is not received.

Further, it is preferable that the master station further includes abnormality detection means for recognizing that the slave station is abnormal when the signal level of the up signal is detected but the up signal is not detected. According to this configuration, the abnormality of the slave station can be detected.

Further, it is preferable that the master station further includes correction means for absorbing variation of a light reception level of the optical signal received from the optical transmission path. According to this configuration, since the light source element on the transmission side can be adjusted to suitable characteristics, it is possible to realize the optical transmission of higher quality.

A slave station in the signal transmission system of the invention is the slave station for the signal transmission system which includes at least one slave station intended for communication and a master station coupled to the slave station through an optical transmission path, including:
receiving means for receiving a down signal which is frequency-multiplexed with a reference signal from the master station;
split means for branching the reference signal from the down signal; and
frequency conversion means for converting a received up signal into a signal of an intermediate frequency band by using the reference signal.

According to this configuration, since the optical transmission characteristics can be improved, the number of the slave stations being coupled can be increased.

Further, it is preferable that the slave station further includes reference signal frequency conversion means for frequency-converting the reference signal thus branched thereby to output a second reference signal, wherein the frequency conversion means converts the up signal into the intermediate frequency band signal by using the second reference signal. According to this configuration, even when the predetermined frequency signal can not be generated in the master station, the reference signal for frequency-converting the up signal into a signal of the intermediate frequency can be generated.

Further, it is preferable that the slave station further includes detecting means for detecting the down signal. According to this configuration, it is possible to detect abnormality etc. by detecting the down signal.

Further, it is preferable that the slave station further includes means for amplifying or attenuating the received down signal; and gain control means for controlling a gain of the amplifying or attenuating means when the detecting means does not detect the down signal. According to this configuration, the power saving can be realized by controlling the amplifying or attenuating means when the down signal is not received. The similar control may be performed by detecting the reference signal instead of the down signal.

A slave station in the signal transmission system of the invention is the slave station for the signal transmission system which includes at least one slave station intended for communication and a master station coupled to the slave station through an optical transmission path, including:
reference signal generation means for generating a reference signal of a predetermined frequency; and
frequency conversion means for converting a received up signal into a signal of an intermediate frequency band by using the reference signal.

According to this configuration, since the optical transmission characteristics can be improved, the number of the slave stations being coupled can be increased.

Further, it is preferable that the reference signal generation means includes signal generation means for generating a signal of a first frequency and reference signal frequency conversion means for converting the first frequency signal into the predetermined frequency signal. According to this configuration, even when the predetermined frequency signal can not be generated, the reference signal for frequency-converting the up signal into a signal of the intermediate frequency can be generated.

Further, it is preferable that the slave station further includes means for multiplexing the reference signal and coupling means for frequency-multiplexing and coupling the multiplexed reference signal with an up signal for the master station.

Further, it is preferable that the slave station further includes coupling means for frequency-multiplexing and coupling the reference signal with an up signal for the master station. According to this configuration, it is possible to send the multiplexed reference signal to the master station.

Further, it is preferable that the slave station further includes electro/optical conversion means for converting the up signal thus converted into the intermediate frequency band into an optical signal, wherein the electro/optical conversion means has a semiconductor laser as a light source. According to this configuration, since the optical transmission characteristics can be improved, a semiconductor laser of a relatively low cost can also be used.

Further, it is preferable that the electro/optical conversion means limits wavelengths of the light source to a predetermined range. According to this configuration, since the transmission loss of a fusion type wavelength multiplexing element can be suppressed, the optical transmission of higher quality can be realized at a low cost.

A signal transmission system of the invention is the signal transmission system including a plurality of slave stations each intended for communication and a master station coupled to the plurality of slave stations through optical transmission paths, respectively, wherein
the slave station including:
slave station frequency conversion means for converting a received up signal into a signal of an intermediate frequency band; and
electro/optical conversion means for converting the up signal thus converted into the intermediate frequency band signal into an optical signal and outputting the optical signal to the master station, and wherein
the master station including:
a plurality of optical/electro conversion means for converting up optical signals of the intermediate frequency band received from the plurality of slave stations into electrical signals, respectively;
synthesizing means for synthesizing the plurality of up signals thus converted into the electrical signals; and
frequency conversion means for converting the up signal of the intermediate frequency band into a signal of a desired frequency band.

According to this system, since the optical transmission characteristics can be improved, the number of the slave stations being coupled can be increased.

A master station in the signal transmission system of the invention is a signal transmission method in the master station for the signal transmission system which includes a plurality of slave stations each intended for communication and the master station coupled to the plurality of slave stations through optical transmission paths, respectively, including the steps of:
receiving an up signal of an intermediate frequency band from the slave station;
converting the received up signal of the intermediate frequency band into an electrical signal from an optical signal;
synthesizing the plurality of up signals corresponding to the plurality of slave stations; and
converting the up signal of the intermediate frequency band into a signal of a desired frequency band by using a reference signal of a predetermined frequency.

According to this method, since the optical transmission characteristics can be improved, the number of the slave stations being coupled can be increased.

A master station in the signal transmission system of the invention is a signal transmission method in a slave station for the signal transmission system which includes at least one slave station intended for communication and the master station coupled to the slave station through an optical transmission path, including the steps of:
receiving a down signal frequency-multiplexed with a reference signal from the master station;
branching the reference signal from the down signal;
receiving an up signal; and
converting the received up signal into a signal of an intermediate frequency band based on the reference signal thus branched.

According to this method, since the optical transmission characteristics can be improved, the number of the slave stations being coupled can be increased.

A master station in the signal transmission system of the invention is a signal transmission method in a slave station for the signal transmission system which includes at least one slave station intended for communication and the master station coupled to the slave station through an optical transmission path, including the steps of:
generating a reference signal of a predetermined frequency; and
converting a received up signal into a signal of an intermediate frequency band by using the reference signal.

According to this method, since the optical transmission characteristics can be improved, the number of the slave stations being coupled can be increased.

A master station in the signal transmission system of the invention is a signal transmission method in the signal transmission system which includes a plurality of slave stations each intended for communication and the master station coupled to the plurality of slave stations through optical transmission paths, respectively, including the steps of:
in the slave station, converting a received up signal into a signal of an intermediate frequency band;
converting the up signal thus converted into the intermediate frequency band signal into an optical signal and outputting the optical signal to the master station;
in the master station, receiving the up optical signals of the intermediate frequency band from the plurality of slave stations and converting the up optical signals into electrical signals;
synthesizing the up signals thus converted in the electrical signals; and
converting the up signal of the intermediate frequency band into a signal of a desired frequency band.

According to this method, since the optical transmission characteristics can be improved, the number of the slave stations being coupled can be increased.

According to the invention, it is possible to provide the signal transmission system which can increase the number of slave stations being coupled with a simple configuration

### BRIEF DESCRIPTION OF THE DRAWINGS

FIG. 1 is a schematic diagram showing the constitution of a signal transmission system for explaining the first embodiment of the invention.

FIG. 2 is a diagram showing an example of the frequency characteristics of the tertiary distortion in the optical transmission.

FIG. 3 is a diagram showing an example of the schematic configuration of an amplifying operation control portion.

FIG. 4 is a diagrams showing the wavelength transmission characteristics of respective wavelength multiplexing types.

FIG. 5 is an explanatory diagram showing a coupling system from a laser diode serving as a light source to an optical fiber as an optical transmission path.

FIG. 6 (a) (b) are diagrams showing examples of the bias current characteristics of the laser diode.

FIG. 7 is a schematic diagram showing the constitution of an up signal transmission system of the signal transmission system for explaining the second embodiment of the invention.

### DESCRIPTION OF THE PREFERRED EMBODIMENTS

### First Embodiment

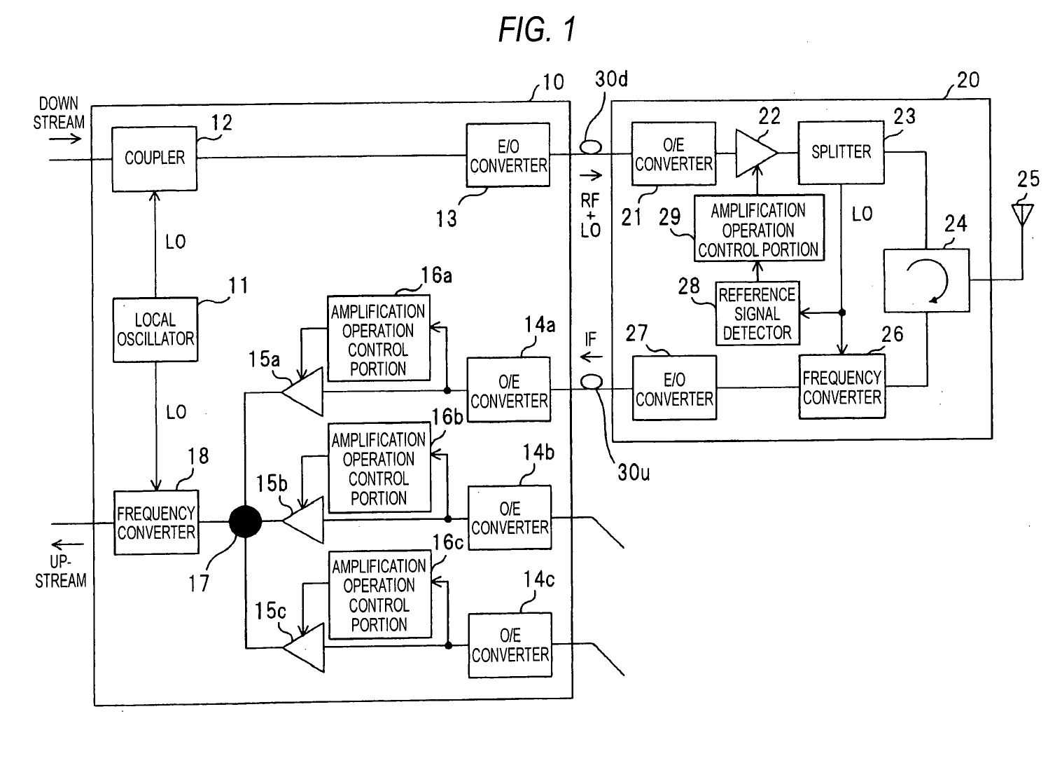

FIG. 1 is a schematic diagram showing the constitution of a signal transmission system for explaining the first embodiment of the invention. This embodiment will be exemplarily explained as to an antenna distribution system applied to a mobile communication system as the signal transmission system.

As shown in FIG. 1, the signal transmission system according to the embodiment includes a master station 10 and slave stations 20 coupled to the master station through optical transmission paths 30. The master station 10 transmits a down signal from a not-shown radio base station to the slave stations 20 and transmits up signals from the slave stations 20 to the radio base station. The slave station 20 has a function as an antenna station and serves to transmit a down signal from the master station 10 to a mobile terminal through an antenna and transmit an up signal from the mobile terminal to the master station 10.

The master station 10 includes a local oscillator 11, a coupler 12, an electro/optical (E/O) converter 13, optical/electro (O/E) converters 14a to 14c, amplification operation control portions 16a to 16c, amplifiers 15a to 15c, a synthesizer 17 and a frequency converter 18.

The local oscillator 11 generates a reference signal of a predetermined frequency. In this respect, the same effects can be obtained even when the reference signal is received from the outside instead of providing the oscillator within the master station. The coupler 12 frequency-multiplexes and couples the reference signal from the local oscillator 11 with the down signal of a radio frequency (RF) band for the slave station 20. The E/O converter 13 converts an electrical signal outputted from the coupler 12 into an optical signal. In this case, when the frequency of the reference signal is smaller than the band width of the radio frequency, for example, when the frequency of the reference signal is 12.8 MHz and the band width of the radio frequency is 20 MHz, if the reference signal is multiplexed with the signal of the radio frequency band, there arises a problem that a secondary distortion component is generated within the transmission band of the radio frequency signal. In such a case, it is desirable to frequency-convert the reference signal by a multiplier (not shown) etc. provided between the local oscillator 11 and the coupler 12 and then to superimpose the signal thus frequency-converted on the radio frequency signal. For example, the secondary harmonics (25.6 MHz) of the reference signal frequency may be superimposed on the radio frequency signal.

Further, at the time of frequency-converting the radio frequency signal of the up signal into the intermediate frequency, if the radio frequency is 2,000 MHz and the intermediate frequency is 500 MHz, it is necessary to input a signal of 1,500 MHz or 2,500 MHz to a frequency conversion means. In this case, if the reference signal of 1,500 MHz or 2,500 MHz can not be obtained, a signal of another frequency generated from another oscillator may be used as a reference signal, then this reference signal may be frequency-converted by using a phase synchronizing circuit etc. into a signal of 1,500 MHz or 2,500 MHz and superimposed on the down signal. In this respect, the similar effect can be obtained even in a case that the reference signal is superimposed as it is on the radio frequency signal within the master station, the reference signal is frequency-converted by using a phase synchronizing circuit etc. within the slave station to obtain a signal of 1,500 MHz or 2,500 MHz and the up signal of the radio frequency is frequency-converted into an intermediate frequency signal by using the frequency-converted signal.

The O/E converters 14a to 14c convert up optical signals of an intermediate frequency band sent from the slave stations into electrical signals, respectively. The amplifiers 15a to 15c amplify the electrical signals from the O/E converters 14a to 14c, respectively. The amplification operation control portions 16a to 16c control the operations of the amplifiers 15a to 15c based on the up signals outputted from the O/E converters 14a to 14c, respectively. In this case, an attenuation operation may be controlled instead of controlling the amplification operation. The synthesizer 17 synthesizes the up signals amplified by the amplifiers 15a to 15c. The frequency converter 18 converts the up signal of the intermediate frequency band applied from the synthesizer 17 into the radio frequency signal by using the reference signal.

For example, when the radio frequency is 2,000 MHz and the intermediate frequency is 500 MHz, it is necessary to input a signal of 1,500 MHz or 2,500 MHz to the frequency converter 18. In this case, if the reference signal of 1,500 MHz or 2,500 MHz can not be obtained, a signal of another frequency generated from another oscillator may be used as a reference signal, then this reference signal may be frequency-converted by using a phase synchronizing circuit etc. to obtain a signal of 1,500 MHz or 2,500 MHz and this frequency-converted signal may be inputted into the frequency converter 18. In this case, the frequency of the signal inputted into the frequency converter 18 is made coincide with the frequency of a signal inputted into the frequency converter 26 of the slave station.

The slave station 20 includes an O/E converter 21, an amplifier 22, a branching filter or splitter 23, a circulator 24, an antenna 25, the frequency converter 26, an E/O converter 27, a reference signal detector 28 and an amplification operation control portion 29.

The O/E converter 21 converts the down signal of the radio frequency multiplexed with the reference signal, which is received from the master station 10 through an optical transmission path 30d, into an electrical signal from an optical signal. The amplifier 22 amplifies the down electrical signal outputted from the O/E converter 21. The splitter 23 splits or brunches the electrical signal supplied from the O/E converter 21 into the radio signal and the reference signal. The circulator 24 sends the down radio signal outputted from the splitter 23 to the antenna 25 and sends the up signal from the antenna 25 to the frequency converter 26.

The frequency converter 26 frequency-converts the up radio signal from the antenna 25 into a signal of the intermediate frequency band. This frequency conversion into the intermediate frequency band is performed by using the reference signal split by the splitter 23. For example, when the radio frequency is 2,000 MHz and the intermediate frequency is 500 MHz, it is necessary to input a signal of 1,500 MHz or 2,500 MHz to the frequency converter 26. In this case, if the frequency of the reference signal split by the splitter 23 is not 1,500 MHz nor 2,500 MHz, the reference signal may be frequency-converted by using a phase synchronizing circuit etc. to obtain a signal of 1,500 MHz or 2,500 MHz and this frequency-converted signal may be inputted into the frequency converter 26. In this case, the frequency of the signal inputted into the frequency converter 26 is made coincide with the frequency of the signal inputted into the frequency converter 18 of the master station. The E/O converter 27 converts an electrical signal outputted from the frequency converter 26 into an optical signal and sends the optical signal to an optical transmission path 30u.

In this manner, in the signal transmission system according to the embodiment, the frequency converter 26 of the slave station 20 converts the up signal into the intermediate frequency band signal from the radio frequency band signal. That is, in the up optical transmission path 30u from the slave station 20 to the master station 10, the signal is transmitted at the intermediate frequency band.

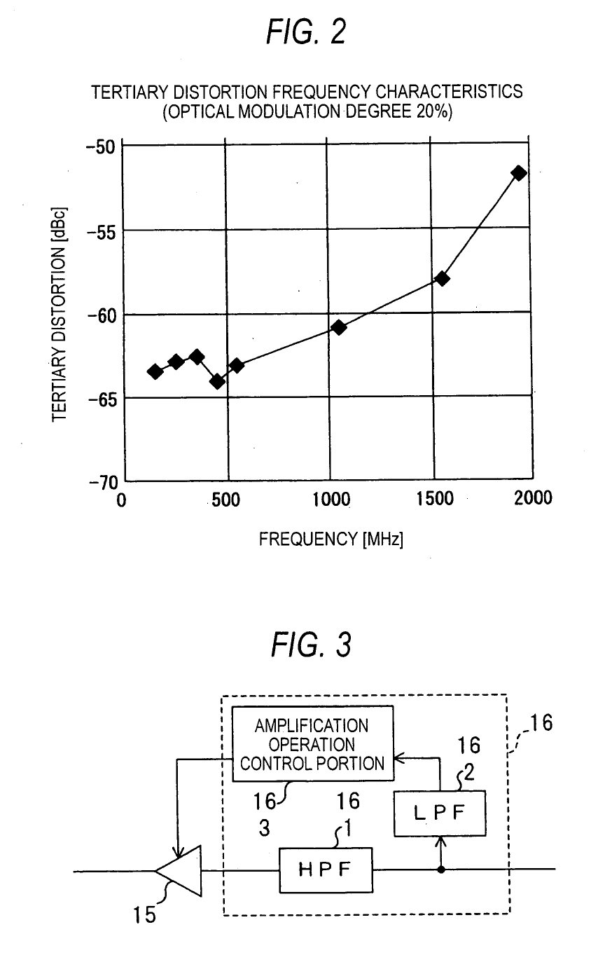

The explanation will be made as to the frequency characteristics of the optical signal in the optical transmission. FIG. 2 is a diagram showing an example of the frequency characteristics of the tertiary distortion in the optical transmission. As shown in FIG. 2, in the optical transmission, the magnitude of distortion tends to increase as the frequency increases. Thus, good distortion characteristics can be obtained in the case of transmitting a signal of the intermediate frequency band of lower frequencies (for example, about 500 MHz) as compared with the case of transmitting a signal of the radio frequency band of higher frequencies (for example, about 2 GHz). Therefore, since the degree of light modulation can be made large in the intermediate frequency band as compared with the radio frequency band, CNR can be improved in the intermediate frequency band.

In this embodiment, since the optical transmission from the slave station 20 to the master station 10 is performed by using the intermediate frequency band as described above, the master station 10 can receive signals of a high CNR from the respective slave stations 20. Further, since a CNR per one slave station 20 is high, the number of signals synthesized by the synthesizer 17 can be made large.

That is, since the optical transmission from the slave stations 20 is performed by the intermediate frequency band, the master station can be coupled to more the slave stations 20 with almost the same signal quality as that after signal synthesizing in the case where the optical transmission is performed by using the radio frequency band.

Next, the synthesizer 17 synthesizes the up signals from the respective slave stations 20 having been converted into the electrical signals by the O/E converters 14a to 14c. Since the synthesizer synthesizes the signals in the form of electrical signals, the generation of beat noises, which is worried about being caused at the time of synthesizing optical signals, can be prevented. Further, in the case of synthesizing the signals in the form of optical signals, it is required to separate from one another the light wavelengths of the light sources for the respective slave stations. However, in this embodiment, since the synthesizer synthesizes the signals having been converted into electrical signals, it is not necessary to differentiate from one another the light wavelengths of the light sources for the respective slave stations.

Further, the synthesizer 17 is provided at the front stage of the frequency converter 18. An electric part such as an amplifier generally exhibits good characteristics as to distortion characteristics etc. in the low frequency range as compared with the high frequency range. Thus, good signal characteristics can be obtained through such a processing that signals received from the respective slave stations 20 are subjected to the electrical processing such as an amplification processing thereby to be synthesized and then the frequency band of the synthesized signal is converted into the radio frequency band.

In the case of performing the frequency conversion before the synthesizing, it is necessary to provides frequency converters which frequency-convert the received signals from the slave stations, respectively. In contrast, in the embodiment, since the frequency conversion is performed after the synthesizing, it is possible to reduce the number of mixers etc. for the frequency conversion thereby to miniaturize the size of the station and reduce the cost thereof.

The frequency converter 18 performs the frequency conversion by using the reference signal generated from the local oscillator 11. This reference signal is superimposed on the down signal for the slave station 20 at the coupler 12. There arises no problem when the reference signal is inputted from the outside instead of generating it by the local oscillator 11. The frequency converter 26 of the slave station 20 converts the radio frequency signal into the intermediate frequency signal by using the reference signal. Thus, since it is not necessary to provide a local oscillator for frequency conversion at the slave station 20, the configuration of the slave station can be simplified.

Further, the frequency of the reference signal used for the frequency conversion on the master station 10 side can be made common to that used for the frequency conversion on the slave stations 20 side. In the case of using the local oscillator separately in the master station and the slave station, since the frequencies of the reference signals generated from theses local oscillators are required to be made coincide accurately, the local oscillators are required to have high accuracy. On the other hand, according to the embodiment, since the frequencies of the reference signals are common between the master station and the slave stations, it is possible to prevent the trouble due to the deviation of the frequency of the reference signal between the master station and the slave stations.

Incidentally, the same effects can also be obtained in the following case. That is, the local oscillator is provided in each of the slave stations instead of the master station, the up radio frequency signal is frequency-converted into the intermediate frequency signal by using the referenced signal generated from the local oscillator, and the reference signal is super imposed with the intermediate frequency signal and then transmitted to the master station. Then, on the master station side, the reference signal is branched from the signal transmitted from the slave station and then the intermediate frequency signal is frequency-converted into the radio frequency signal by using the referenced signal thus branched.

In the master station 10, the amplification operation control portions 16a to 16c are provided which control the operations of the amplifiers 15a to 15c for amplifying the received signals, respectively.

FIG. 3 is a diagram showing an example of the schematic configuration of the amplifying operation control portion. The amplification operation control portion 16 includes a high pass filter (HPF) 161, a low pass filter (LPH) 162 and an operation switching portion 163. The low frequency component of the up electrical signal outputted from the O/E converter 14 is removed by the high pass filter 161, whilst the d.c. component of the up electrical signal is extracted by the low pass filter 162 provided for d.c. component detection. The operation switching portion 163 has such a function of switching the power supply for the amplifier 15, for example. That is, the operation switching portion confirms the presence or non-presence of the d.c. component and controls the amplifier 15 so as to turn off the operation (power supply) of the amplifier 15 when the signal is not sent from the slave station 20. Thus, for example, when there is a slave station not being used, the operation of the amplifier for this slave station is stopped thereby to save the electric power consumed in the slave station. Further, in this case, the signal synthesized by the synthesizer 17 can be prevented from being degraded in its CNR. Alternatively, when there is a slave station not being used, the signal synthesized by the synthesizer 17 can also be prevented from being degraded in its CNR in a manner that an attenuator is provided in place of the amplifier and the attenuation amount of the attenuator for this slave station is increased.

Other various kinds of the methods can be applied to the embodiment as the method of detecting the signal from the slave station. For example, the embodiment maybe configured in a manner that a pilot signal is superimposed on the up signal in the slave station 20, and the amplification operation control portion 16 turns off the power supply of the amplifier 15 when the pilot signal is not detected.

Next, the slave station 20 includes the reference signal detector 28 thereby to make it possible to detect the reference signal superimposed on the down signal. This reference signal is used for the frequency conversion and also may serve as the pilot signal. The reference signal detector 28 monitors the reference signal and detects the disconnection etc. of the optical transmission path in accordance with the presence or non-presence of the reference signal. Thus, it is possible to notify an alarm by means of a not-shown alarm notifying portion (a display portion and a sound output portion) etc. Incidentally, in this case, the down signal (for example, the d.c. component of the down signal) may be detected in place of the reference signal.

The amplification operation control portion 29 controls the power supply for the amplifier 22 of the slave station 20 in accordance with the detection of the reference signal by the reference signal detector 28. For example, in a case where the slave station is not used despite that it is installed or there arises an abnormality such as disconnection of the optical transmission path, the slave station 20 does not detect the reference signal. Thus, the amplification operation control portion 29 turns off the power supply for the amplifier 22, whereby the electric power consumed in the slave station can be saved. Further, a noise signal transmitted from the antenna 25 can be reduced. In this case, a noise signal transmitted from the antenna 25 can also be reduced by increasing the attenuation amount of an attenuator which is used in place of the amplifier in a case where the slave station is not used or there arises an abnormality such as disconnection of the optical transmission path and hence the reference signal is not detected. Incidentally, in this case, the down signal (for example, the d.c. component of the down signal) may be detected in place of the reference signal thereby to perform the aforesaid control in accordance with the detection result of the down signal.

A semiconductor laser such as a Fabry-Perot laser is used as a light source used in the E/O converter 27 of the slave station. Although the Fabry-Perot laser is relatively cheap, it is a laser light source having a relatively wide range in its spectrum center wavelength and the characteristics thereof is degraded than a DFB (Distributed Feedback) laser. However, since the signal transmission system according to this embodiment has excellent distortion characteristics by transmitting the signal at the intermediate frequency from the slave station to the master station, the CNR can be improved by increasing the optical modulation degree of the RF signal. Thus, sufficient signal quality can be obtained even if such a laser is used.

Next, the explanation will be made as to a case where the WDM (Wavelength Division Multiplexing) is performed in which the up and down communications are performed by using a single optical fiber as the optical transmission path 30. In this case, different frequencies (wavelengths) are used between the up and down communications. As the wavelength multiplexing in the WDM, there are the fusion type and the filter type.

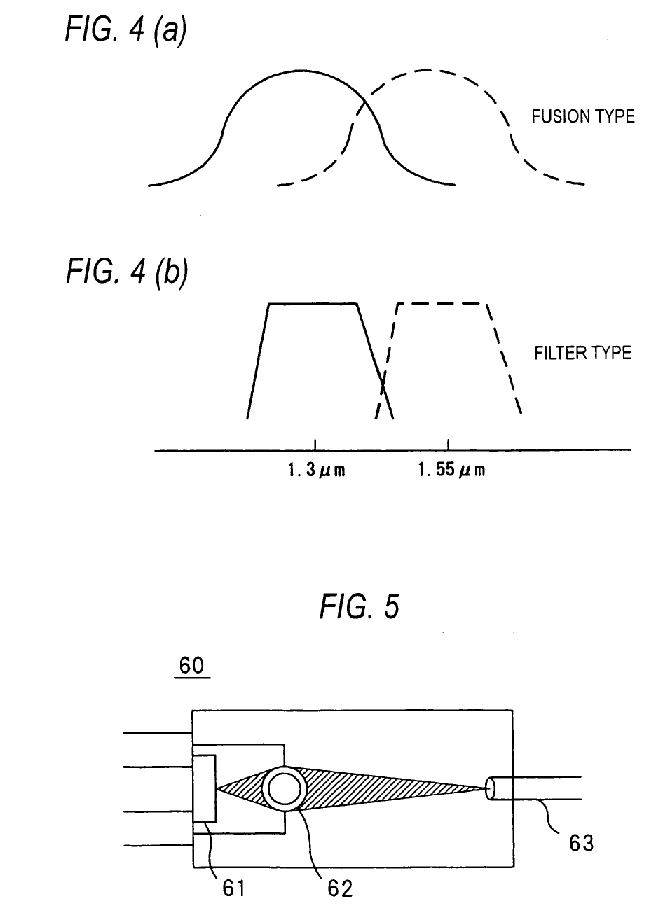

FIG. 4 is diagrams showing the wavelength transmission characteristics of the respective wavelength multiplexing types, in which FIG. 4(a) shows the characteristics of the fusion type and FIG. 4(b) shows the characteristics of the filter type. As shown in FIG. 4(a), the fusion type is gentle in its wavelength transmission characteristics and has features that the loss becomes large when the wavelength range spreads but the cost is low. In contrast, as shown in FIG. 4(b), the filter type is steep in its wavelength transmission characteristics and has features that the loss is low in the wide wavelength range but the cost is high.

In the case where the Fabry-Perot laser is used in the WDM, since the center wavelength range of the spectrum is wide as described above, loss becomes large when this laser is used as it is as a light source in the fusion type. Thus, when the Fabry-Perot laser is used so as to limit the wavelength range thereof to a predetermined range, the fusion type WDM of a relatively cheap cost can be realized by a relatively cheap Fabry-Perot laser. The limited wavelength range is in a range of about ±20 nm around the center frequency of the laser, for example.

In the example of FIG. 4, supposing that the frequency of the up signal is 1.31 μm and the frequency of the down signal is 1.55 μm, the Fabry-Perot laser is used for the signal transmission in a manner that the wavelength range thereof is limited to 1.31 μm±20 nm for the up signal and to 1.55 μm±20 nm for the down signal.

FIG. 5 is an explanatory diagram showing a coupling system from the E/O converter to the optical transmission path, that is, from the laser diode serving as the light source to the optical fiber as the optical transmission path. As shown in FIG. 5, a laser diode 61 emits a laser light in accordance with a current flowing therein. The laser light thus emitted is converged at the optical fiber 63 through a lens 62 and the optical fiber 63 transmits the converged light.

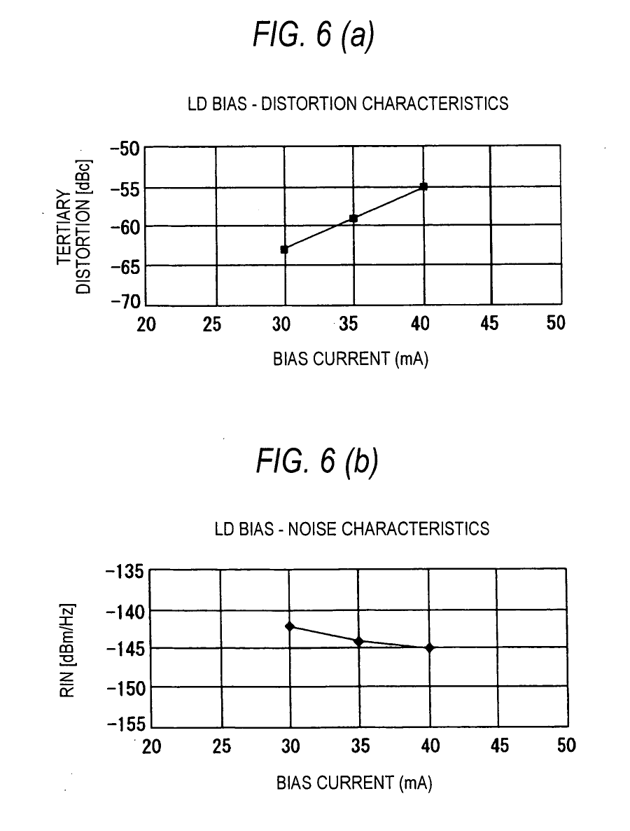

The efficiency of the laser diode depends on a bias current applied thereto. FIG. 6 is diagrams showing examples of the bias current characteristics of the laser diode. FIG. 6(a) shows an example of the bias current to distortion characteristics (mutual (tertiary) distortion characteristics) and FIG. 6(b) shows an example of the bias current to noise characteristics (RIN: Relative Intensity Noise characteristics).

As shown in FIGS. 6(a) and 6(b), the distortion characteristics tends to increase its distortion with the increase of the bias current applied to the diode, whilst the noise characteristics tends to decrease its noise with the increase of the bias current applied to the diode. Although the relative relations of the distortion characteristics and the noise characteristics with respect to the bias current may slightly differ from those of FIGS. 6(a) and 6(b) depending on the kind of a laser diode, each laser diode has any kinds of the bias current dependency. Thus, it is preferable to improve the optical transmission characteristics by limiting the range of the bias current in accordance with the bias current dependency of the laser diode thereby to adjust the characteristics of the light source element.

However, in the coupling system shown in FIG. 5, the coupling efficiency varies actually due to the variation of the light converging position etc. from the lens 62 to the optical fiver 63. As a result, the level of the light emitted to the optical. fiber 63 varies due to the variation of the light converging position etc. Thus, it is preferable to provide a constitution for absorbing the light emitting variety at the device on the receiving side. For example, a light attenuator is provided so as to absorb the variation at the front stage of the O/E converter 14a in the master station 10 or at the front stage of the O/E converter 21 in the slave station. Alternatively, the variation may be absorbed by the electric processing after converting the optical signal into the electrical signal.

Thus, since the light source element can be adjusted to have an optimum characteristic by providing a means for correcting the variation of light emission (the variation of light reception on the receiving side), the optical transmission with better quality can be realized.

According to the signal transmission system of the first embodiment of the invention, since the optical transmission is performed at the intermediate frequency band, the optical transmission characteristics is improved and the number of the slave stations to be coupled can be increased.

### Second Embodiment

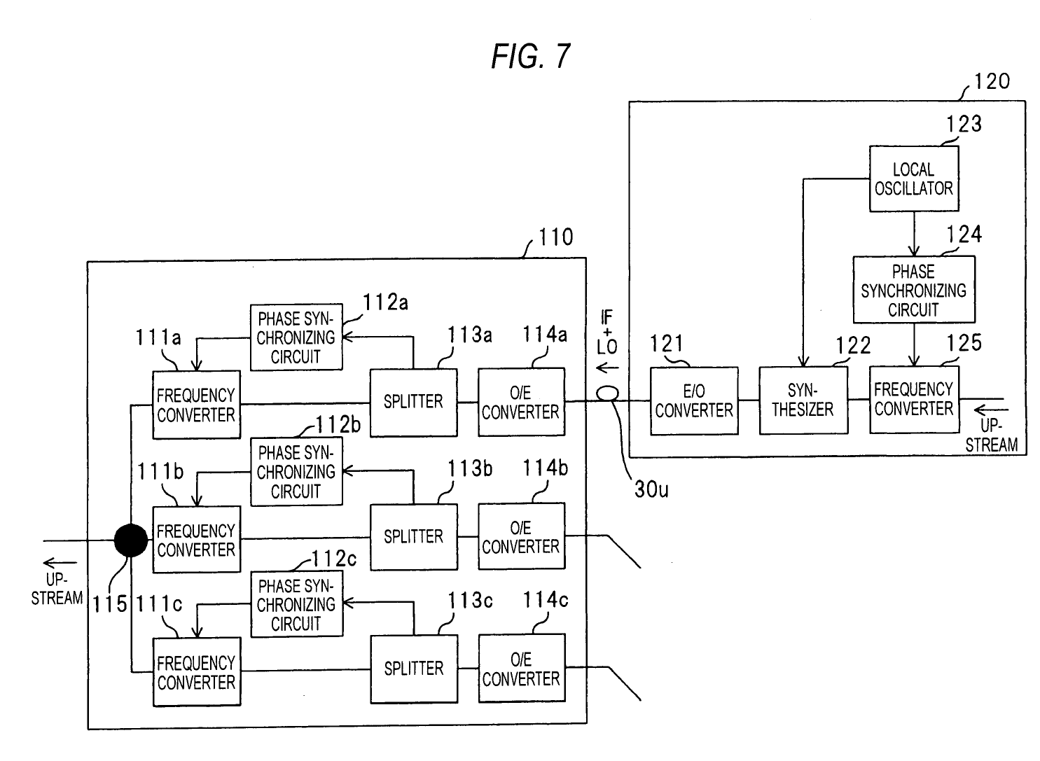

FIG. 7 is a schematic diagram showing the constitution of the up signal transmission system of the signal transmission system for explaining the second embodiment of the invention. This embodiment will be exemplarily explained as to an antenna distribution system applied to a mobile communication system as the signal transmission system.

As shown in FIG. 7, the signal transmission system according to this embodiment includes a master station 110 and slave stations 120 coupled to the master station through optical transmission paths 30. The master station 110 transmits an up signal from the slave stations 120 to a base station. The slave station 120 has a function as an antenna station and serves to transmit an up signal from a mobile terminal to the master station 110.

The master station 110 includes frequency converters 111a to 111c, phase synchronizing circuits 112a to 112c, branching filters or splitters 113a to 113c, O/E converters 114a to 114c and a synthesizer 115.

Each of the O/E converters 114a to 114c converts an up optical signal, in which an intermediate frequency band from the slave station and a reference signal from a local oscillator 123 provided at the slave station 120 are multiplexed, into an electrical signal. The phase synchronizing circuits 112a to 112c input the signals from the local oscillators branched by the splitters 113a to 113c and obtain oscillator outputs synchronized with the input signals, respectively. The frequency converters 111a to 111c convert the up signals of the intermediate frequency band into radio frequency signals by using the oscillator outputs outputted from the phase synchronizing circuits 112a to 112c, respectively. The synthesizer 115 synthesizes the radio frequency signals frequency-converted by the frequency converters 111a to 111c.

The slave station 120 includes an E/O converter 121, a synthesizer 122, a local oscillator 123, a phase synchronizing circuit 124 and a frequency converter 125.

The E/O converter 121 converts an electrical signal outputted from the synthesizer 122 into an optical signal. The synthesizer 122 synthesizes the reference signal from the local oscillator 123 with the intermediate frequency signal generated by the frequency converter 125. The local oscillator 123 generates the reference signal of a predetermined frequency. The phase synchronizing circuit 124 inputs the reference signal from the local oscillator 123 and obtains an oscillator output synchronized with the input signal. The frequency converter 125 converts an up signal of the radio frequency band into a signal of the intermediate frequency band by using the oscillator output outputted from the phase synchronizing circuit 124.

In the case where the frequency of the reference signal is smaller than the radio frequency band width, for example, the frequency of the reference signal is 12.8 MHz and the radio frequency band width is 20 MHz, when the reference signal is superimposed on the signal of the radio frequency band, there arises a problem that the secondary distortion component is generated within the transmission band of the radio frequency signal. In such a case, it is desirable to superimpose the reference signal on the radio frequency signal after frequency-converting the reference signal by a multiplier (not shown) etc. provided between the local oscillator 123 and the synthesizer 122. For example, the secondary harmonics (25.6 MHz) of the reference signal frequency may be superimposed on the radio frequency signal.

Thus, the frequency of the reference signal used in the frequency-conversion becomes common between the master station 110 and the slave stations 120. When the local oscillator is used separately in the master station and the slave station, since it is necessary to accurately coincide the frequencies of these reference signals from one another, it is required to provide the local oscillators with a high accuracy. On the other hand, according to the configuration of this embodiment, since the frequency of the reference signal is common between the master station and the slave stations, it is possible to prevent a problem due to a difference of the frequencies of the reference signals between the master station and the slave station.

This configuration has a problem that the number of the parts such as the local oscillators is larger as compared with the signal transmission system according to the embodiment shown in FIG. 1. However, since the up signal transmission system and the down signal transmission system are provided separately, the configuration of this embodiment is effective in a case where the independency of the up signal transmission system and the down signal transmission system is important.

The signal transmission system according to the invention has the effect that the number of the slave stations to be coupled can be increased with the simple configuration and is useful for the antenna system etc. of the mobile communication system etc.

1. A master station for a signal transmission system which includes a plurality of slave stations each intended for communication and the master station coupled to the plurality of slave stations through optical transmission paths, respectively, comprising:
a plurality of optical/electro converter, converting up optical signals of an intermediate frequency band received from the plurality of slave stations into electrical signals, respectively;
a combiner, synthesizing the plurality of up signals; and
a frequency converter, converting the up signal of the intermediate frequency band into a signal of a desired frequency band by using a reference signal of a predetermined frequency.

2. The master station according to claim 1, further comprising:
a reference signal generator, generating the reference signal.

3. The master station according to claim 2, wherein the reference signal generator includes a signal generator for generating a signal of a first frequency and a reference signal frequency converter for converting the first frequency signal into the predetermined frequency signal.

4. The master station according to claim 1, further comprising:
a receiver, receiving the reference signal from outside.

5. The master station according to one of claims 1 to 4, further comprising:
a first coupler, frequency-multiplexing and coupling the reference signal with a down signal for the slave station.

6. The master station according to one of claims 1 to 4, further comprising:
a multiplier, multiplying the reference signal; and
a second coupler, frequency-multiplexing the multiplied reference signal with a down signal for the slave station.

7. The master station according to one of claims 1 to 6, wherein the frequency converter for converting the intermediate frequency band signal into the desired frequency band signal is disposed at a rear stage of the combiner for synthesizing the plurality of up signals.

8. The master station according to claim 1, wherein the up signal received from the slave station is frequency-multiplexed with the reference signal, and the master station further comprising:
a splitter, branching the reference signal from the up signal.

9. The master station according to claim 1, wherein the up signal received from the slave station is frequency-multiplexed with a signal of a second frequency, and the master station further comprising:
a splitter, branching the second frequency signal from the up signal; and
a reference signal frequency converter, converting the second frequency signal into the predetermined frequency signal and outputting the predetermined frequency signal as the reference signal.

10. A master station according to claim 8 or 9, wherein the frequency converter for converting the intermediate frequency band signal into the desired frequency band signal is disposed at a front stage of the combiner for synthesizing the plurality of up signals.

11. The master station according to one of claims 1 to 10, further comprising:
means for amplifying or attenuating each of the up signals received from the plurality of slave stations;
a detector, detecting a signal level of the up signal; and
a gain controller, controlling a gain of the amplifying or attenuating means when the detector does not detect the up signal.

12. The master station according to one of claims 1 to 10, further comprising:
a abnormality detector, recognizing that the slave station is abnormal when the signal level of the up signal is detected but the up signal is not detected.

13. The master station according to one of claims 1 to 10, further comprising:
a corrector, absorbing variation of a light reception level of the optical signal received from the optical transmission path.

14. The slave station for a signal transmission system which includes at least one slave station intended for communication and a master station coupled to the slave station through an optical transmission path, comprising:
a receiver, receiving a down signal which is frequency-multiplexed with a reference signal from the master station;
a splitter, branching the reference signal from the down signal; and
a frequency converter, converting a received up signal into a signal of an intermediate frequency band by using the reference signal.

15. The slave station according to claim 14, further comprising:
a reference signal frequency converter, frequency-converting the reference signal thus branched thereby to output a second reference signal, wherein
the frequency converter converts the up signal into the intermediate frequency band signal by using the second reference signal.

16. The slave station according to claim 14 or 15, further comprising:
a detector, detecting the down signal.

17. The slave station according to claim 16, further comprising:
means for amplifying or attenuating the received down signal; and
a gain controller, controlling a gain of the amplifying or attenuating means when the detector does not detect the down signal.

18. A slave station for a signal transmission system which includes at least one slave station intended for communication and a master station coupled to the slave station through an optical transmission path, comprising:
a reference signal generator, generating a reference signal of a predetermined frequency; and
a frequency converter, converting a received up signal into a signal of an intermediate frequency band by using the reference signal.

19. The slave station according to claim 18, wherein
the reference signal generator includes a signal generator for generating a signal of a first frequency and reference signal frequency converter for converting the first frequency signal into the predetermined frequency signal.

20. The slave station according to claim 18 or 19, further comprising:
a third coupler, frequency-multiplexing and coupling the reference signal with an up signal for the master station.

21. The slave station according to claim 18 or 19, further comprising:
a multiplier, multiplying the reference signal; and
a fourth coupler, frequency-multiplexing and coupling the multiplied reference signal with an up signal for the master station.

22. The slave station according to one of claims 18 to 21, further comprising:
an electro/optical converter, converting the up signal thus converted into the intermediate frequency band into an optical signal, wherein
the electro/optical converter has a semiconductor laser as a light source.

23. The slave station according to claim 22, wherein the electro/optical converter limits wavelengths of the light source to a predetermined range.

24. A signal transmission system including a plurality of slave stations each intended for communication and a master station coupled to the plurality of slave stations through optical transmission paths, respectively, wherein
the slave station comprising:
a slave station frequency converter, converting a received up signal into a signal of an intermediate frequency band; and
an electro/optical converter, converting the up signal thus converted into the intermediate frequency band signal into an optical signal and outputting the optical signal to the master station, and wherein
the master station comprising:
a plurality of optical/electro converter, converting up optical signals of the intermediate frequency band received from the plurality of slave stations into electrical signals, respectively;
a combiner, synthesizing the plurality of up signals thus converted into the electrical signals; and
a frequency converter, converting the up signal of the intermediate frequency band into a signal of a desired frequency band.

25. A signal transmission method in a master station for a signal transmission system which includes a plurality of slave stations each intended for communication and the master station coupled to the plurality of slave stations through optical transmission paths, respectively, comprising the steps of:
receiving an up signal of an intermediate frequency band from the slave station;
converting the received up signal of the intermediate frequency band into an electrical signal from an optical signal;
synthesizing the plurality of up signals corresponding to the plurality of slave stations; and
converting the up signal of the intermediate frequency band into a signal of a desired frequency band by using a reference signal of a predetermined frequency.

26. The signal transmission method in a slave station for a signal transmission system which includes at least one slave station intended for communication and a master station coupled to the slave station through an optical transmission path, comprising the steps of:
receiving a down signal frequency-multiplexed with a reference signal from the master station;
branching the reference signal from the down signal;
receiving an up signal; and
converting the received up signal into a signal of an intermediate frequency band based on the reference signal thus branched.

27. A signal transmission method in a slave station for a signal transmission system which includes at least one slave station intended for communication and a master station coupled to the slave station through an optical transmission path, comprising the steps of:
generating a reference signal of a predetermined frequency; and
converting a received up signal into a signal of an intermediate frequency band by using the reference signal.

28. A signal transmission method in a signal transmission system which includes a plurality of slave stations each intended for communication and a master station coupled to the plurality of slave stations through optical transmission paths, respectively, comprising the steps of:
in the slave station, converting a received up signal into a signal of an intermediate frequency band;
converting the up signal thus converted into the intermediate frequency band signal into an optical signal and outputting the optical signal to the master station;
in the master station, receiving the up optical signals of the intermediate frequency band from the plurality of slave stations and converting the up optical signals into electrical signals;
synthesizing the up signals thus converted in the electrical signals; and
converting the up signal of the intermediate frequency band into a signal of a desired frequency band.
